(19) United States
(12) Patent Application Publication
(10) Pub. No.: US 2026/0296633 A1
(43) Pub. Date: Oct. 1, 2026

(54) AIRCRAFT

(71) Applicant: Airbus Defence and Space GmbH, Taufkirchen (DE)

(72) Inventor: Franz-Michael Sendner, Taufkirchen (DE)

(21) Appl. No.: 19/556,295

(22) Filed: Mar. 4, 2026

(30) Foreign Application Priority Data
Mar. 28, 2025 (DE) 102025112205.9

(51) Int. Cl. B64C 9/04; B64C 39/04

(52) U.S. Cl. CPC B64C 9/04; B64C 39/04

(57) ABSTRACT

An aircraft includes a fuselage, a wing assembly, a propulsion device, and two tail booms, each including a stem and a stabilizing surface, wherein the stabilizing surfaces of the tail booms are each arranged symmetrically with respect to the respective stem of the tail boom, wherein the stabilizing surfaces of the tail booms are arranged at an angle to one another such that upper edges of the stabilizing surfaces have a smaller spacing than lower edges of the stabilizing surfaces, and wherein each of the stabilizing surfaces has a tilting device for controlling the aircraft.

### TECHNICAL FIELD

The disclosure herein relates to an aircraft.

### BACKGROUND

One fundamental aim in aviation is to minimize the structural weight of an aircraft in order to enhance utility in the form of transported load or energy storage devices.

However, methods for reducing the weight of individual components may have the side effect of influencing the structural and aerodynamic stability of the aircraft. Particularly in the sector of relatively small, e.g. unmanned, aircraft, this results in a balance between weight reduction, controllability and resilience with respect to aerodynamic loads on the aircraft. Accommodating payloads can entail additional requirements in the arrangement of structural and control surfaces, which cannot be met, for example, by a typical arrangement involving just one fuselage boom and control surfaces mounted thereon. One attempt to harmonize these conflicting interests involves the use of tail booms to stabilize the aircraft.

There are also concepts that enable such booms to contribute to the control of the aircraft. However, previously known tail booms cannot control the movement around all the axes of rotation with sufficient reliability, and therefore additional control devices, e.g. ailerons mounted on the wings of the aircraft, are required. These control devices contribute significantly to the weight and complexity of the aircraft.

### SUMMARY

Given this background, it is the underlying object of the disclosure herein to provide an aircraft of reduced structural weight without losing manoeuvrability or structural stability.

According to the disclosure herein, this object is achieved by an aircraft having features disclosed herein.

Accordingly, an aircraft, having a fuselage, a wing assembly, a propulsion device, and two tail booms, each comprising a stem and a stabilizing surface, is provided. The stabilizing surfaces of the tail booms are each arranged symmetrically with respect to the respective stem of the tail boom. The stabilizing surfaces of the tail booms are arranged at an angle to one another in such a way that upper edges of the stabilizing surfaces have a smaller spacing than lower edges of the stabilizing surfaces. Each of the stabilizing surfaces has a tilting device for controlling the aircraft.

The concept underlying the disclosure herein consists in advantageously distributing the aerodynamic load acting on the tail booms by symmetrical embodiment of the stabilization surfaces. In particular, the torsional moment acting on the respective stem can be minimized or completely eliminated. This makes it possible to perform control of the aircraft exclusively by the tail booms, thereby making it possible to save material in such a way that the weight of the aircraft can be advantageously reduced and the functionality of systems arranged on the aircraft can be optimized or extended.

Advantageous embodiments and further developments will become apparent from the further dependent claims and from the description with reference to the figures.

According to a further development, each tilting device is arranged in such a way that the respective stabilizing surface can be fully tilted. This can facilitate the design of the aircraft since the stem and the stabilizing surface can be formed separately and then connected by the tilting device.

According to a further development, each tilting device is arranged in such a way that the respective stabilizing surface is divided into a tiltable control surface and a non-tiltable connecting surface. It is thereby possible to advantageously optimize the aerodynamic properties and stability of the tail boom.

According to a further development, the wing assembly is configured as a monoplane, in particular as a V-shaped monoplane. This is an advantageously simple, reduced-weight embodiment which is made possible by the embodiment according to the disclosure herein of the tail booms.

According to a further development, the propulsion device is mounted on the fuselage. This allows an advantageously increased overall stability of the aircraft.

According to a further development, the aircraft has two propulsion devices, which are arranged on the wing assembly so as to correspond to the two tail booms. This makes it possible to improve the functionality of systems mounted on the fuselage since, in this embodiment, they are not hindered by a propulsion device.

According to a further example embodiment, the aircraft has two or more fuselages. This may be of advantage, depending on the payload requirements on the aircraft.

According to another example embodiment, the aircraft has an even number of tail booms. This may be of advantage, depending on the payload requirements on the aircraft.

The above embodiments and further developments can be combined with one another in any way desired, insofar as this is worthwhile. Further possible embodiments, further developments and implementations of the disclosure herein also comprise combinations, not explicitly mentioned, of features of the disclosure herein which are described above or below in relation to the example embodiments. In particular, a person skilled in the art will also add individual aspects as improvements or supplementary features to the respective basic form of the disclosure herein.

### BRIEF DESCRIPTION OF THE DRAWINGS

The disclosure herein is explained in greater detail below with reference to the example embodiments indicated in the schematic figures. Here,

FIG. 1 shows an aircraft according to an example embodiment of the disclosure herein;

FIG. 2 shows an aircraft according to an example embodiment of the disclosure herein;

FIG. 3 shows a tail boom of an aircraft according to an example embodiment of the disclosure herein.

### DETAILED DESCRIPTION

The appended figures are intended to impart greater understanding of the embodiments of the disclosure herein. They illustrate embodiments and are used to explain principles and concepts of the disclosure herein in conjunction with the description. Other embodiments and many of the advantages mentioned will be apparent from viewing the drawings. The elements of the drawings are not necessarily shown to scale relative to one another.

In the figures of the drawing, elements, features and components that are the same, functionally the same and have the same effect are each provided with the same reference signs, unless stated otherwise.

FIG. 1 shows an aircraft 100. The aircraft has a fuselage 110, a wing assembly 120, a propulsion device 130, and two tail booms 140. Each of the tail booms 140 has a stem 141 and a stabilizing surface 142.

The stabilizing surfaces 142 of the tail booms 140 are each arranged symmetrically with respect to the respective stem 141 of the tail boom 140. The stabilizing surfaces 142 of the tail booms 140 are arranged at an angle to one another in such a way that upper edges of the stabilizing surfaces 142 have a smaller spacing than lower edges of the stabilizing surfaces 142. Each of the stabilizing surfaces has a tilting device 143 for controlling the aircraft.

The aircraft 100 can be controlled by actuating the respective tilting devices 143. Actuating the tilting devices 143 symmetrically gives rise to air flows which impart a pitching movement to the aircraft 100. Antisymmetric actuation of the tilting devices 143 causes a movement which has both a rolling and a yawing component. The tail booms 140 can thus fully control the aircraft without the need for other control devices. This enables the wing assembly 120 to be embodied as a V-shaped monoplane, as shown in FIG. 1. Since the tail booms are not connected to one another, it is possible by unilateral actuation of the respective tilting devices to mitigate loads due to asymmetric gusts if these are detected in a timely manner by a corresponding device.

Each tilting device 143 is arranged in such a way that the respective stabilizing surface 142 is divided into a tiltable control surface and a non-tiltable connecting surface. This allows finer adjustment of the aerodynamic properties of the tail booms 140. The tilting devices 143 may also be arranged in such a way that the respective stabilizing surface 142 can be fully tilted, thereby for example making the fabrication of the aircraft 100 easier.

The propulsion device 130 is mounted on the fuselage 110. The alignment of the propulsion device 130 along the central axis of the aircraft 100 supports the stability of the aircraft when it is being controlled by the tail booms 140.

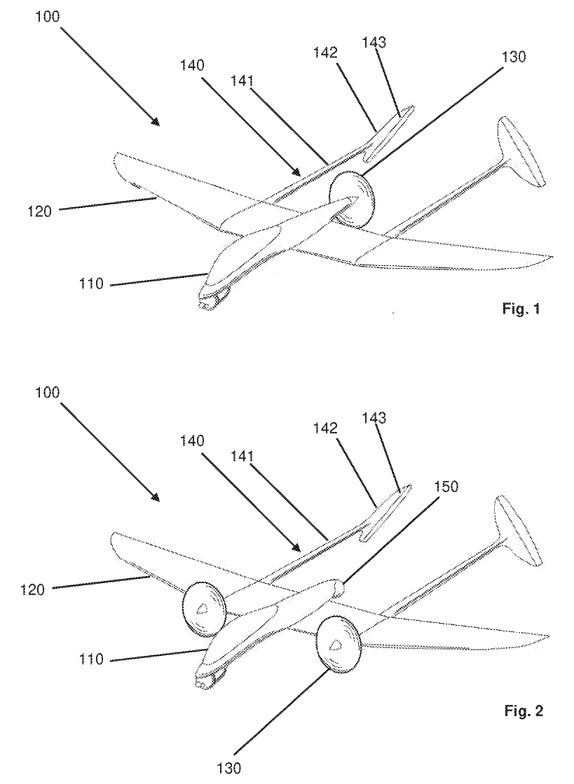

FIG. 2 shows an aircraft 100 having essentially the features shown in FIG. 1. The aircraft 100 shown in FIG. 2 has two propulsion devices 130, which are arranged on the wing assembly 120 so as to correspond to the two tail booms 140.

In the embodiment shown in FIG. 2, an active system 150 can be arranged at the rear of the fuselage 110, for example, the system having a free field-of-view as well as accessibility both in flight and on the ground since it is not obstructed by the propulsion devices 130 or the tail booms 140.

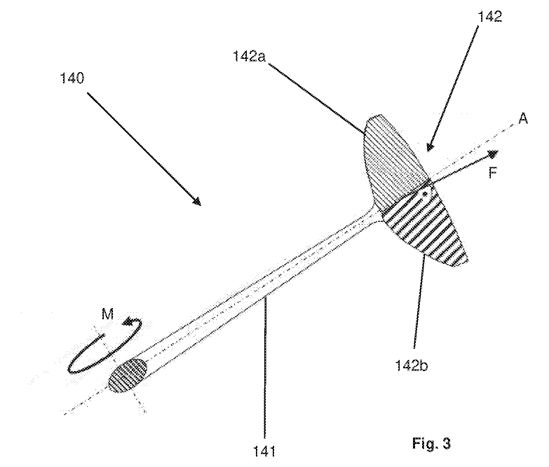

FIG. 3 shows a tail boom 140 according to one example embodiment of the disclosure herein. The tail boom 140 has a stem 141 and a stabilizing surface 142. The stabilizing surface 142 is arranged symmetrically with respect to the stem 141. For the sake of greater clarity, no tilting device is shown in FIG. 3.

As can be seen in FIG. 3, the stabilizing surface 142 is divided into two identical partial surfaces 142a and 142b, which are arranged symmetrically with respect to the elastic axis A of the stem 141. Aerodynamic loading of the stabilizing surface 142 results in a force F which acts on the stabilizing surface perpendicularly to the elastic axis A. The resulting bending moment M acting on the stem 141 is likewise perpendicular to the elastic axis A, for which reason there is no torsional load on the stem 141.

The embodiment of the stem 141, especially as regards material, cross section and wall thickness of the stem, can advantageously be directly matched to this pure bending load.

In the example embodiments in the figures, the aircraft shown each have a single fuselage. However, it is also conceivable that an aircraft according to one example embodiment of the disclosure herein has two or more fuselages. Particularly in the case of unmanned aircraft, this may be an advantageous embodiment, depending on the payload of the aircraft.

The aircraft shown in the figures likewise each have precisely two tail booms. In principle, however, it is possible and, depending on the embodiment, sometimes advantageous to fit an aircraft with an even number of tail booms according to the disclosure herein, e.g. four or six.

While at least one example embodiment of the disclosure herein(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiments. In addition, in this disclosure, the terms “comprise” or “comprising” do not exclude other elements or steps, the terms “a” or “one” do not exclude a plural number, and the term “or” means either or both. Furthermore, characteristics or steps, which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

100 aircraft

110 fuselage

120 wing assembly

130 propulsion device

140 tail boom

141 stem

142 stabilizing surface

142a partial surface

142b partial surface

143 tilting device

150 active system

A elastic axis

F force

M bending moment

1. An aircraft, comprising:
a fuselage;
a wing assembly;
a propulsion device; and
two tail booms, each comprising a stem and a stabilizing surface;
wherein the stabilizing surfaces of the tail booms are each arranged symmetrically with respect to a respective stem of the tail boom;
wherein the stabilizing surfaces of the tail booms are arranged at an angle to one another such that upper edges of the stabilizing surfaces have a smaller spacing than lower edges of the stabilizing surfaces; and
wherein each of the stabilizing surfaces has a tilting device for controlling the aircraft.

2. The aircraft according to claim 1, wherein each tilting device is arranged such that the respective stabilizing surface can be fully tilted.

3. The aircraft according to claim 1, wherein each tilting device is arranged such that the respective stabilizing surface is divided into a tiltable control surface and a non-tiltable connecting surface.

4. The aircraft according to claim 1, wherein the wing assembly is configured as a monoplane.

5. The aircraft according to claim 4, wherein the wing assembly is configured as a V-shaped monoplane.

6. The aircraft according to claim 1, wherein the propulsion device is mounted on the fuselage.

7. The aircraft according to claim 1, wherein the aircraft has two propulsion devices, which are arranged on the wing assembly so as to correspond to the two tail booms.

8. The aircraft according to claim 1, wherein the aircraft has two fuselages.

9. The aircraft according to claim 1, wherein the aircraft has an even number of tail booms.
